(19) United States
(12) Patent Application Publication
(10) Pub. No.: US 2006/0117483 A1
(43) Pub. Date: Jun. 8, 2006

(54) Tiltable vetinary surgical cradle

(76) Inventor: Chad M. Devitt, Parker, CO (US)

Correspondence Address: J. PRESTON OXENHAM;J. PRESTON OXENHAM P.C., SUITE 200, 3515 SO TAMARAC DRIVE, DENVER, CO, 80237, US

(21) Appl. No.: 11/002,717

(22) Filed: Dec. 2, 2004

(51) Int. Cl. A61G 13/04

(52) U.S. Cl. 5/621

(57) ABSTRACT

A cradle for supporting a patient during a surgical procedure includes a supporting base adapted to rest upon a supporting surface and a cradle body for embracing and supporting a patient in proper posture to undergo performance of a surgical procedure. A cradle body support structure supports the cradle body above the supporting base in such a manner that the cradle body may rotate about a horizontal, longitudinal cradle body rotational axis to change the position of the patient while the cradle body maintains the patient in proper surgical posture.

### TECHNICAL FIELD

The present invention relates to devices for the physical support of patients during surgical procedures. More particularly, the present invention relates to devices for the support of patients during endoscopic surgical procedures. Most particularly, the present invention relates to devices for the support of patients during the performance of laparoscopic assisted OHE (ovarian hysterectomy) veterinary procedures performed on dogs.

### BACKGROUND OF THE INVENTION

Endoscopic procedures have replaced many more traditional invasive surgical procedures in contemporary human and veterinary medical practices, and the development of new endoscopic, trauma-minimizing procedures in both human and veterinary medicine is continuing at a steady pace.

Many endoscopic procedures require that patients be placed and maintained in a favorable posture and/or position to facilitate manipulation of endoscopic and surgical instruments and equipment. In the course of performing many of these procedures it is necessary to change the patient's posture and/or position as the various elements of the protocol of the procedure are performed. Particularly during procedures involving exploration or the performance of surgery upon organs at disparate locations in a body cavity, it may be advantageous to change the patient's body orientation to allow gravity to act upon organs and body tissues to facilitate viewing of and access to various organs and other physiological elements.

Patient physical support devices utilized in the surgical arts of the past have allowed the posture and position of patients to be manipulated during surgical and endoscopic procedures. Some have provided adjustable panels and other restraint and support devices to maintain the patient in a fixed position or posture. However, these tables have generally required manipulation of the patient by hand to achieve adjustment of the patient's posture or position during the course of a surgical procedure, introducing risks associated with displacement of anesthesia and surgical equipment elements and the failure to maintain an aseptic environment.

### DISCLOSURE OF THE INVENTION

It is an object of the present invention to provide an operating table which will facilitate changing the position of a surgery patient during the course of a surgical procedure.

It is a further object of the present invention to provide an operating table which will allow a patient to be rotated about a horizontal, lateral axis to utilize gravity to assist in displacement of organs and body tissues in body cavities while maintaining the patient in a constant, fixed posture during endoscope assisted medical procedures.

It is yet another object of the present invention to facilitate such rotation of a patient from a position of dorsal recumbency to positions of right or left lateral recumbency during a veterinary, laparoscopic assisted spay procedure while maintaining an aseptic surgical field.

In keeping with the above objectives, a surgical cradle comprising a preferred embodiment of the present invention includes a cradle body and cradle support base. The cradle body has walls which are joined at about 90 degrees to form a trough. The cradle body is provided with a narrow longitudinal flat base and is supported above the support base to allow it to rotationally tilt about a longitudinal axis beneath the cradle base. The cradle body may be locked in an upright position by passing a locking pin through a locking pin hole in an end panel of the support base and into one of the cradle body side walls.

The cradle support base has an upper support surface central portion and raised upper surface side portions running along its longitudinal edges. With the locking pin removed the cradle body may be tilted left or right to bring the exterior surface of a cradle body side wall to a condition of repose, resting upon the upper support surface of the support base. In this position, the distal edge of the cradle body side wall lies immediately adjacent to the inner edge of raised upper cradle support base surface and the inner surface of the side wall and the adjacent raised surface portion align to provide a generally continuous, planar work surface.

An animal may be anithised, placed in the cradle body in dorsal recumbent position, and taped or strapped in proper posture for performance of an endoscopic procedure. In the course of the procedure, the animal may readily be moved from a dorsal recumbent to a right or left side lateral recumbent position while maintaining the animals posture and the aseptic surgical field.

Other objects, advantages and aspects of the invention will become apparent upon perusal of the following detailed description and claims and upon reference to the accompanying drawings.

### BRIEF DESCRIPTION OF THE DRAWINGS

FIG. 1 is an isometric view of a surgical cradle comprising a preferred embodiment of the present invention positioned for dorsal recumbency.

FIG. 2 is an isometric view of a surgical cradle comprising a preferred embodiment of the present invention positioned for right lateral recumbency.

FIG. 3 is an isometric view of a surgical cradle comprising a preferred embodiment of the present invention positioned for left lateral recumbency.

FIG. 4 is an end view of the surgical cradle in the configuration of FIG. 1.

FIG. 5 is a side view of the surgical cradle in the configuration of FIG. 1.

FIG. 6 is an end view of the surgical cradle in the configuration of FIG. 3.

### DETAILED DESCRIPTION

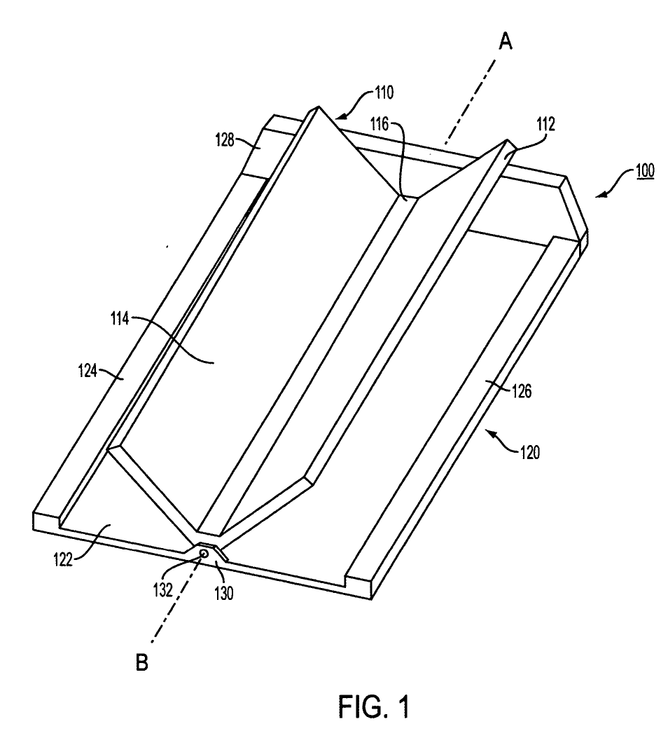

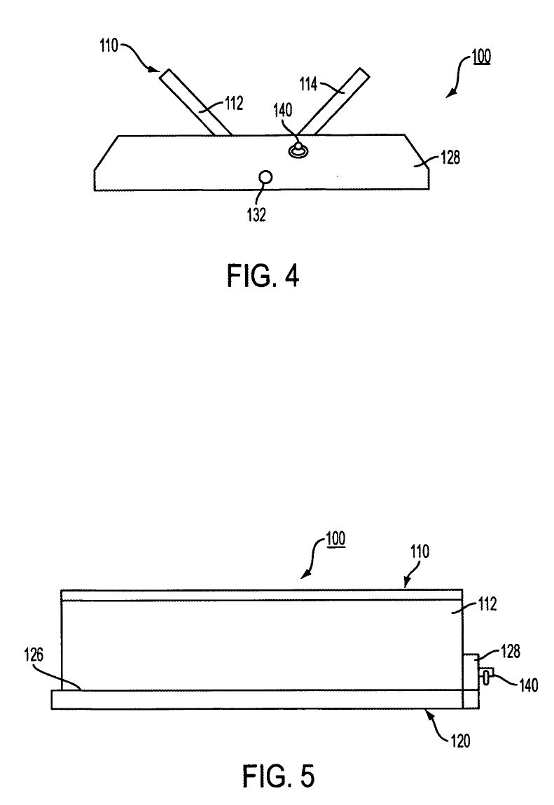

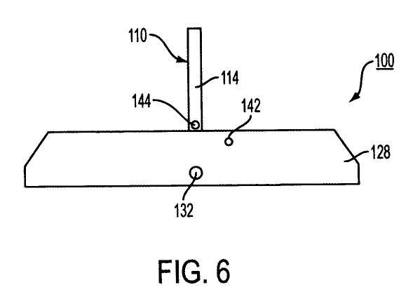

Surgical cradle 100 comprising a preferred embodiment of the present invention is shown in FIGS. 1 through 6, and includes cradle body 110 and cradle support base 120. Cradle body 110 includes cradle body walls 112 and 114, which are joined to form an angle of about 90 degrees beneath cradle body base 116. Cradle body 110 of the preferred embodiment of FIG. 1 is supported, in a manner to allow it to rotationally tilt about longitudinal axis A-B, by cradle body support pins 132 passing through cradle support pillar 130, as may be seen in FIGS. 1, 2 and 3, and cradle support base end panel 128, as may be seen in FIGS. 4 and 6. As may be seen in FIGS. 4, 5 and 6, cradle body 110 may be locked in the upright configuration of FIG. 1 by passing locking pin 140 through end panel locking pin hole 142 and into cradle body locking pin hole 144 in cradle body side wall 114.

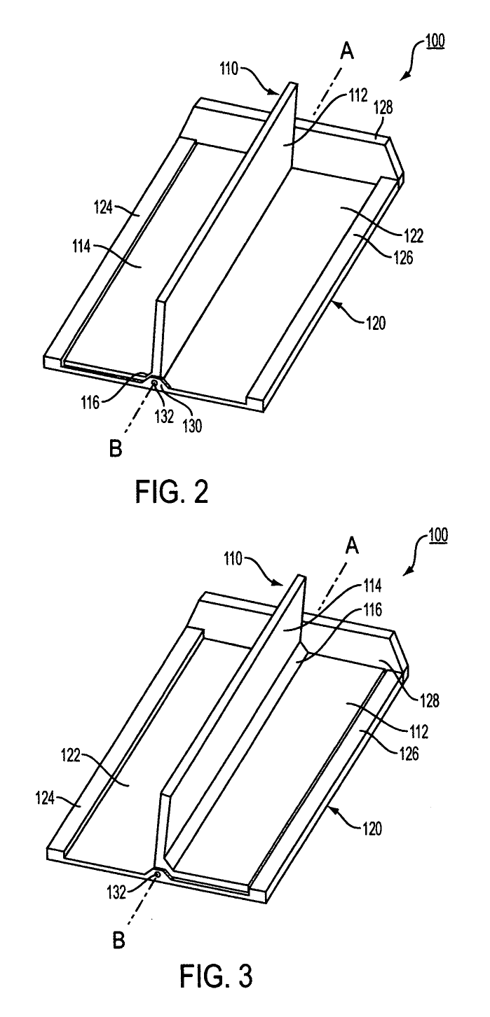

Cradle support base 126 has upper support surface 122 over its central portion and raised upper surface portions 124 and 126 running along its longitudinal edges. With locking pin 140 removed from locking pin holes 142 and 144, cradle body 110 may be tilted to bring the exterior surface of cradle body side wall 114 to a condition of repose, resting upon upper support surface 122 of cradle support base 120, as shown in FIG. 2. With cradle body 110 in this position, the distal edge of cradle body side wall 114 lies immediately adjacent to the inner edge of raised upper cradle support base surface 124 and the inner surface of side wall 114 and surface 124 align to provide a generally continuous, planar work surface. Also, with locking pin 140 removed, cradle body 110 may be tilted to bring the exterior surface of cradle body side wall 112 to rest upon upper support surface 122 of cradle support base 120, as shown in FIG. 3. With cradle body 110 in this position, the distal edge of cradle body side wall 112 lies immediately adjacent to the inner edge of raised upper cradle support base surface 126 and the inner surface of side wall 112 and surface 126 align to provide a generally continuous, planar work surface.

When the surgical cradle of the present invention is to be utilized to perform a veterinary laparoscopic assisted two portal OHE procedure, the cradle support base of the exemplary embodiment is placed on the surface of a standard veterinary surgical table. The animal upon which the spay procedure is to be performed is then placed in a position of dorsal recumbence in the cradle body such that cradle body sides 112 and 114 retain the animal in a centered position with cradle base 116 supporting the center of the animals back with its head toward support base end panel 128. The animal's posture and position within cradle body 110 may be fixed by taping its legs and body to cradle walls 112 and 114 with an appropriate surgical tape. The cradle may also be provided with retention straps equipped with buckles, press type or other suitable fasteners, and attached to the edges of cradle walls 112 and 114 to facilitate securing the animal in proper posture and position in the cradle. While the animal is in dorsal recumbence, with locking pin 140 engaged in end panel lock pin hole 142 and side wall lock pin hole 144, a pneumoperitoneum is raised to a suitable pressure in a standard manner. A cannula is established at the level of the umbilicus, and this first portal is used to insert the laparoscope.

Locking pin 140 is then removed from locking pin holes 144 and 142 and cradle body 110 is rotated about rotational axis A-B to bring cradle body side 114 to rest upon support surface 122 of base 120 and place the patient in right lateral recumbence, with cradle body 110 in the position of FIG. 2. This causes gravity to draw the spleen, bowel and body tissues to the right side of the animal's pressurized body cavity to allow the abdominal viscera to be viewed and the left ovariouterine complex to be identified and appropriate surgical procedures to be performed.

The cradle and patient are then rotated about rotational axis A-B to bring cradle body side 112 to rest upon support surface 122 of base 120 and place the patient in left lateral recumbence, with cradle body 110 in the position of FIG. 3. This causes gravity to draw the bowel, pancreas and body tissues to the left side of the animal's pressurized body cavity to allow the right ovarian pedicle to be identified, and appropriate surgical procedures performed in a similar fashion to the left side procedure.

Upon completion of the right side surgical procedure, cradle body 110 is returned to the position of FIGS. 1 and 6 and, locking pin 140 is again passed through locking pin hole 142 of end panel 128 and into locking pin hole 144 of cradle body side wall 114 to lock cradle body 110 in that position such that the patient is once again placed in dorsal recumbence in the cradle body with cradle body sides 112 and 114 retaining the animal in a centered position with cradle base 116 supporting the center of the animals back.

A second, caudal portal is then established at the caudal midline with a trocar, through which the right and left ovary and associated tissues are removed through the body wall and final internal surgical procedures are performed. Both portal sites are then closed.

Those familiar with the art will note that, while application of an exemplary embodiment of the present invention for a veterinary laparoscopic assisted OHE procedure has been explained, the tiltable surgical cradle of the present invention may have applications other than for this veterinary laparoscopic spaying procedure. For example, applications might include procedures on other animals, exploratory endoscopic procedures, and procedures in human medicine.

Further, while an exemplary surgical cradle comprising embodiments of the present invention has been shown, it will be understood, of course, that the invention is not limited to this embodiment. Modification may be made by those skilled in the art, particularly in light of the foregoing teachings. For example, the cradle support base might be provided with legs so it could be utilized standing directly on a floor or the surgical cradle might otherwise be integrated with a conventional operating table. The base of the cradle body might be rounded and allowed to rest directly upon the support base supporting surface while fixed in place by alternating flexible straps fixed to the cradle body at one end and to the support surface at the other. A plurality of end panel holes might be provided to allow the cradle to be locked in positions other than those of strict dorsal or lateral recumbency. It is, therefore, contemplated by the appended claims to cover any such modification which incorporates the essential features of this invention or which encompasses the spirit and scope of the invention.

I claim:

1. A cradle for supporting a patient during a surgical procedure comprising:
cradling means for nestingly supporting a patient in proper body configuration to undergo performance of a surgical procedure, said cradling means having a longitudinal axis;
a supporting base adapted to rest upon a supporting surface; and,
cradle support means for rotatably supporting said cradling means above said supporting base in such a manner that said cradling means may rotate about a cradling means rotational axis parallel to said longitudinal cradling means axis.

2. A cradle for supporting a patient during a surgical procedure as in claim 1, further comprising:
said cradling means includes a cradle body having a first side wall and a second side wall, said first and second side walls generally lying in a first and second plane, respectively, said first and second plane intersecting generally along said cradling means rotational axis, such that internal surfaces of said first and second side walls define a cradling space.

3. A cradle for supporting a patient during a surgical procedure as in claim 2, further comprising:
said first and second walls are oriented, generally, one normal to the other.

4. A cradle for supporting a patient during a surgical procedure as in claim 2, further comprising:
a cradle body base support surface, said cradle body base support surface extending from an internal surface of said first side wall to an internal surface of said second side wall, and extending over a length of said cradlle body.

5. A cradle for supporting a patient during a surgical procedure as in claim 4, further comprising:
locking means for locking said cradle body in a fixed rotational position about said cradling means rotational axis relative to said supporting base.

6. A cradle for supporting a patient during a surgical procedure as in claim 5, further comprising:
when said cradle body means is locked in said fixed rotational position, a bisecting plane including said cradling means rotational axis and bisecting said cradling space, is generally a vertical plane.

7. A cradle for supporting a patient during a surgical procedure as in claim 6, further comprising:
said supporting base has an upper supporting surface area; and,
said first and second side walls have a first and second external surface, respectively, such that said first external surface comes to rest against said supporting surface when said first side wall is rotated to an angle generally 90 degrees away from said bisecting plane and said second external surface comes to rest against said supporting surface area when said second side wall is rotated to an angle generally 90 degrees away from said bisecting plane.

8. A cradle for supporting a patient during a surgical procedure as in claim 6, further comprising:
said supporting base has a generally horizontal upper cradle side wall support surface area; and,
said first and second side walls have a first and second external surface, respectively, such that said first external surface is brought to rest against said cradle side wall support surface area when said first side wall is rotated away from said bisecting plane to a horizontal position and said second external surface comes to rest against said cradle side wall support surface area when said second side wall is rotated away from said bisecting plane to a horizontal position.

9. A cradle for supporting a patient during a surgical procedure as in claim 8, further comprising:
said first side wall has a first side wall edge distal from said rotational axis;
said second side wall has a second side wall edge distal from said rotational axis;
said cradle side wall support surface area has a first distal edge generally coinciding with said first side wall distal edge when said first side wall external surface comes to rest against said side wall support surface;
said supporting base has a first distal raised surface adjoining and raised above said side wall support surface such that, when said first side wall external surface is at rest against said side wall support surface, said first raised surface provides a continuing planar extension of said first side wall internal surface;
said cradle side wall support surface area has a second distal edge generally coinciding with said second side wall distal edge when said second side wall external surface comes to rest against said side wall support surface; and,
said supporting base has a second distal raised surface adjoining and raised above said side wall support surface such that, when said second side wall external surface is at rest against said side wall support surface, said second raised surface provides a continuing planar extension of said second side wall internal surface.

10. A cradle for supporting a patient during a surgical procedure as in claim 1, further comprising:
locking means for locking said cradling means in a fixed rotational position about said cradling means rotational axis relative to said supporting base.

11. A cradle for supporting a patient during a surgical procedure as in claim 2, further comprising:
said cradle support means comprises an upper cradle support surface upon which said cradling means rests and a flexible strip, a first portion of said strip attached to said cradle support surface and a second portion of said strip attached to an external surface of said side walls.

12. A cradle for supporting a patient during a surgical procedure as in claim 2, further comprising:
said cradle support means comprises a first and a second pillar and first and second hinge pins passing through said first and second pillar respectively.

13. A cradle for supporting a patient during a surgical procedure as in claim 2, further comprising:
said cradle support means comprises a hinge.

14. A cradle for supporting a patient during a surgical procedure as in claim 5, further comprising:
a generally planar end panel fixed to said supporting base, said end panel rotatably fixed to a first end of said cradle body at its rotational axis, said panel having an inner surface defining a locking pin hole;
a pillar fixed to said supporting base, said pillar rotatably fixed to a second end of said cradle body at its rotational axis;
said first cradle body side wall includes an end surface, said end surface defining a locking pin receiving cavity positioned to be alignable with the locking pin hole; and,
an elongate locking pin including a locking pin end and a handle end, said locking pin end sized to pass through said locking pin hole to be received into the locking pin cavity in nested relation.

15. A cradle for supporting a patient during a surgical procedure as in claim 8, further comprising:
said end panel includes a plurality of inner surfaces defining locking pin holes alignable with the locking pin receiving cavity.

16. A veterinary surgical cradle comprising:
a cradle with a longitudinal axis for embracing and confining an animal to a fixed body configuration along a horizontal longitudinal axis generally parallel to the cradle axis;
support means for resting upon a surface and supporting said cradle and allowing said cradle to rotate about an axis generally parallel to its longitudinal axis.

17. The veterinary surgical cradle of claim 16, further comprising:
said cradle is a trough having an elongate base extending horizontally from a first end to a second end and having an upper surface and a longitudinal axis and a first and second side wall said side walls extending upwardly and outwardly from a first and second side of said base, respectively;
said support means includes a support base extending from a first end to a second end, a pillar at said first end rising to pivotally attached to and support said first end of said base and a panel rising from said second end and pivotally attached to said base and a first and second side support surface for supporting said first and second side walls respectively when said base rotates sufficiently to bring said first and second side wall to rest upon said first and second side support surface respectively.

18. The veterinary surgical cradle of claim 17, further comprising:
said first and second side walls have first and second interior surfaces respectively; and,
said support means includes a first and second extended side work surface extending outward from said first and second side support surfaces respectively such that, when said first side wall is supported by said first support surface said first work surface provides an extension of said first side wall interior surface and when said second side wall is supported by said second support surface said second work surface provides an extension of said second side wall interior surface.

19. The veterinary surgical cradle of claim 18, further comprising:
means for locking said trough in an upright position.

20. A method of repositioning a veterinary patient between positions of dorsal recumbence and right and left lateral recumbence during an endoscopic surgical procedure while maintaining an aseptic surgical field comprising:
providing an aseptic trough shaped surgical cradle which can be tilted to positions of left and right repose and fixed in an upright position,
fixing the cradle in the upright position;
placing an animal in dorsal recumbent position in the trough and fastening the animal to the trough in a position favorable to the performance of the surgical procedure;
tilting the cradle to the right and left positions of repose during the procedure; and;
removing the animal from the cradle upon conclusion of the procedure.
